(19) United States
(12) Patent Application Publication
(10) Pub. No.: US 2024/0412404 A1
(43) Pub. Date: Dec. 12, 2024

(54) INFORMATION PROCESSING APPARATUS, INFORMATION PROCESSING METHOD, AND NON-TRANSITORY COMPUTER-READABLE MEDIUM

(71) Applicant: CANON KABUSHIKI KAISHA, Tokyo (JP)

(72) Inventor: TAKAYUKI TSUTSUMI, Kanagawa (JP)

(21) Appl. No.: 18/737,307

(22) Filed: Jun. 7, 2024

(30) Foreign Application Priority Data
Jun. 9, 2023 (JP) 2023-095782

(51) Int. Cl. G06T 7/70; G06V 10/25

(52) U.S. Cl. CPC G06T 7/70; G06V 10/25; G06V 2201/07

(57) ABSTRACT

An information processing apparatus is provided. The apparatus determines, in order to detect a peak position in a score map, whether a position of interest in the score map indicates the peak position. The apparatus selects a new position of interest based on a relationship between (i) a score at the position of interest and (ii) a score at a first position within a region of a predetermined size around the position of interest.

### BACKGROUND

### Field of the Disclosure

The present disclosure relates to an information processing apparatus, an information processing method, and a non-transitory computer-readable medium, and particularly relates to a technique for detecting a peak position in a score map generated using a neural network.

### Description of the Related Art

In the field of information processing, processing is sometimes used to detect a peak position in a score map. For example, hierarchical computation methods (pattern recognition methods based on deep learning techniques), such as convolutional neural networks (CNNs), are attracting attention as object detection methods that are robust with respect to fluctuations in objects. The peak position in a score map output by the final layer of a CNN is sometimes extracted in order to achieve robust object detection. The score map can indicate a score for each position. Meanwhile, the score can indicate the likelihood that the object is present at the corresponding position, for example. In this case, the extracted peak position can indicate a result of estimating the position of the object.

Japanese Patent Laid-Open No. 2005-221241 (“Patent Literature (PTL)1” hereinafter) and Murase (Institute of Electronics, Information and Communication Engineers Transactions, D-II, Vol. J81-D-II, No. 9, pp. 2035-2042; “Non-Patent Literature (NPL) 1” hereinafter) disclose methods of detecting a peak position in a score map. PTL 1 proposes a method for extracting a pixel of interest as a peak pixel when the value of the pixel of interest is determined to be higher than the values of all neighboring pixels, or equal to the highest value among the values of the neighboring pixels. NPL 1, meanwhile, proposes a method for searching for a peak point faster by using color histograms and upper limits on similarity scales to reduce regions to be compared.

### SUMMARY

According to an embodiment of the present disclosure, an information processing apparatus comprises one or more memories storing instructions and one or more processors that execute the instructions to determine, in order to detect a peak position in a score map, whether a position of interest in the score map indicates the peak position; and select a new position of interest based on a relationship between (i) a score at the position of interest and (ii) a score at a first position within a region of a predetermined size around the position of interest.

According to another embodiment of the present disclosure, an information processing apparatus comprises one or more memories storing instructions and one or more processors that execute the instructions to select a position of interest in a score map; compare the score at the position of interest with a threshold; and determine whether the position of interest indicates a peak position according to a determination criterion in order to detect a peak position in the score map, in response to the score at the position of interest being determined to be greater than or equal to a threshold, wherein the determination criterion includes the score at the position of interest and a score at each of positions in a region of a predetermined size around the position of interest satisfying a relationship defined for each of the positions, and the one or more processors execute the instructions to select the position of interest to satisfy a part of the determination criterion.

According to still another embodiment of the present disclosure, an information processing method comprises determining, in order to detect a peak position in a score map, whether a position of interest in the score map indicates the peak position; and selecting a new position of interest based on a relationship between (i) a score at the position of interest and (ii) a score at a first position within a region of a predetermined size around the position of interest.

According to yet another embodiment of the present disclosure, an information processing method comprises selecting a position of interest in a score map; comparing the score at the position of interest with a threshold; and determining whether the position of interest indicates a peak position according to a determination criterion in order to detect a peak position in the score map, in response to the score at the position of interest being determined to be greater than or equal to a threshold, wherein the determination criterion includes the score at the position of interest and a score at each of positions in a region of a predetermined size around the position of interest satisfying a relationship defined for each of the positions, and wherein the selecting includes selecting the position of interest to satisfy a part of the determination criterion.

According to yet still another embodiment of the present disclosure, a non-transitory computer-readable medium stores computer-executable instructions executable by a computer to perform a method comprising determining, in order to detect a peak position in a score map, whether a position of interest in the score map indicates the peak position; and selecting a new position of interest based on a relationship between (i) a score at the position of interest and (ii) a score at a first position within a region of a predetermined size around the position of interest.

According to still yet another embodiment of the present disclosure, a non-transitory computer-readable medium stores computer-executable instructions executable by a computer to perform a method comprising selecting a position of interest in a score map; comparing the score at the position of interest with a threshold; and determining whether the position of interest indicates a peak position according to a determination criterion in order to detect a peak position in the score map, in response to the score at the position of interest being determined to be greater than or equal to a threshold, wherein the determination criterion includes the score at the position of interest and a score at each of positions in a region of a predetermined size around the position of interest satisfying a relationship defined for each of the positions, and wherein the selecting includes selecting the position of interest to satisfy a part of the determination criterion.

Further features of various embodiments will become apparent from the following description of exemplary embodiments (with reference to the attached drawings).

### BRIEF DESCRIPTION OF THE DRAWINGS

FIGS. 1A to 1C are diagrams illustrating an example of the hardware configuration of an information processing apparatus according to one embodiment.

FIGS. 2A to 2C are diagrams illustrating examples of feature maps.

FIG. 3 is a flowchart illustrating an information processing method according to one embodiment.

FIG. 4 is a flowchart illustrating an information processing method according to one embodiment.

FIG. 5 is a flowchart illustrating an information processing method according to one embodiment.

FIGS. 6A to 6E are diagrams illustrating an example of a peak determination method.

FIGS. 7A to 7C are diagrams illustrating an example of a peak determination method.

FIG. 8 is a flowchart illustrating an information processing method according to one embodiment.

FIG. 9 is a diagram illustrating a method for selecting a pixel of interest.

FIGS. 10A and 10B are diagrams illustrating a method for selecting a pixel of interest.

FIG. 11 is a diagram illustrating a method for selecting a pixel of interest when using reduction processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

The sizes of score maps are trending larger in recent years. There is thus a need to accelerate processing for detecting a peak position.

The method disclosed in PTL 1 involves performing processing for determining whether all pixels of interest are peak pixels. As such, the processing in the method of PTL 1 takes a relatively long time. It is particularly difficult to accelerate the processing in the method of PTL 1 when many peak points are present in the score map. On the other hand, in the method proposed by NPL 1, some processing is skipped based on a degree of similarity with an image designated in advance. The method of NPL 1 therefore requires similar images to be prepared in advance, which limits the situations in which the method can be applied. The method of NPL 1 is particularly unsuitable for recognition processing using machine learning.

Some embodiments of the present disclosure make it possible to accelerate the detection of a peak position in a score map.

### Overall Configuration

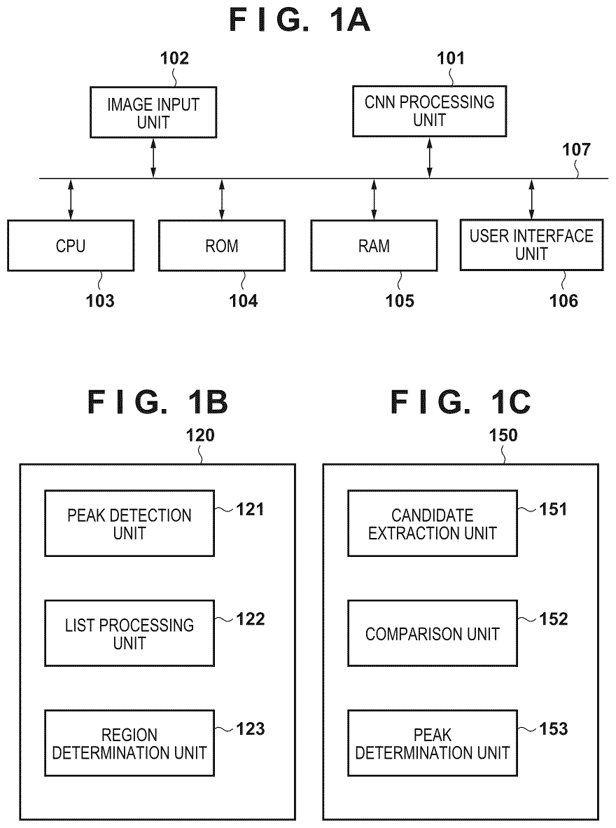

An information processing apparatus according to some embodiments detects a peak position in a score map. The information processing apparatus according to some embodiments may be an image capturing apparatus or a smartphone. The functions of each processing unit of the information processing apparatus illustrated in FIGS. 1B and 1C can be implemented using a processor. However, at least some of the processing units may be implemented by dedicated hardware. Additionally, the information processing apparatus may be constituted by a plurality of information processing apparatuses connected over a network, for example.

FIG. 1A is a diagram illustrating an example of the hardware configuration of an information processing apparatus according to one embodiment. A CNN processing unit 101 generates a score map. For example, the CNN processing unit 101 can generate the score map by performing object detection processing on an image to be processed. The CNN processing unit 101 can generate the score map based on the likelihood that an object is present at each of positions in an input image. The CNN processing unit 101 may generate a feature map other than a score map, however.

An image input unit 102 obtains the image to be processed (the input image). The image input unit 102 may be a photoelectric conversion device. The photoelectric conversion device may include an optical system, such as a lens, and a sensor. The photoelectric conversion device may also include a driver circuit for controlling the sensor, an AD converter, and the like. The sensor may be a charge-coupled device (CCD) or a complementary metal oxide semiconductor (CMOS), for example.

A central processing unit (CPU) 103 controls the information processing apparatus as a whole. A read-only memory (ROM) 104 can store commands and parameters that define the operations of the CPU 103. A random access memory (RAM) 105 is a work memory used by the CPU 103 for operations. The RAM 105 can be a high-capacity dynamic random access memory (DRAM), for example.

A user interface unit 106 obtains inputs from a user of the information processing apparatus. The user interface unit 106 outputs information to the user of the information processing apparatus. The user interface unit 106 may include a display device that displays results of processing such as the object detection processing, for example. The user interface unit 106 may be a button or a touch panel that accepts user inputs. The user interface unit 106 may obtain the inputs from the user or output the information to the user through a graphical user interface (GUI). For example, the user may designate an object detection processing task using the GUI.

A data bus 107 is a data transfer channel among the aforementioned units.

In this manner, the functions of the units illustrated in FIGS. 1B, IC, and the like can be implemented by a processor such as the CPU 103 executing programs stored in a memory such as the ROM 104 or the RAM 105. Note that the CNN processing unit 101 may be dedicated hardware. However, the functions of the CNN processing unit 101 may be implemented by a processor such as the CPU 103.

The following will mainly describe an example in which the information processing apparatus detects a detection target object (called simply an “object” hereinafter) from an image to be processed. In the example in FIG. 1A, the CNN processing unit 101 generates a feature map by processing the image to be processed using a neural network (e.g., a CNN). The feature map is feature data that can be represented using two-dimensional coordinates, for example. The CNN processing unit 101 can execute designated CNN computation in accordance with instructions from the CPU 103. The CNN processing unit 101 stores the generated feature map in the RAM 105. Then, in the object detection, the CPU 103 performs various detection tasks based on the feature map generated by the CNN processing unit 101.

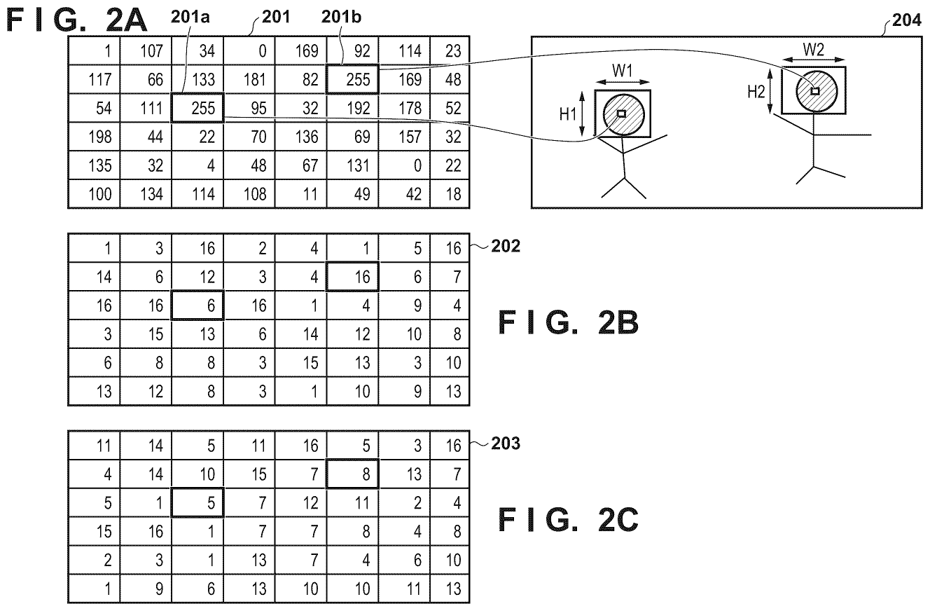

FIGS. 2A to 2C illustrate an example of feature maps output by the CNN processing unit 101. The CNN processing unit 101 outputs feature maps corresponding to an image 204 by performing CNN processing. In this example, the CNN processing unit 101 outputs a score map 201, a region width map 202, and a region height map 203 as the feature maps. As described here, the CNN processing unit 101 can generate a plurality of feature maps corresponding to an object. The CNN used by the CNN processing unit 101 is trained to output these feature maps.

In the examples in FIGS. 2A to 2C, the score map 201, the region width map 202, and the region height map 203 have eight columns×six rows of values. As such, each map is represented by a plurality of values arranged vertically and horizontally. A single position on a map may be called a “pixel” hereinafter. A single pixel corresponds to a single position on the map. The single pixel also corresponds to a specific position in the image 204. In this example, the positional relationship between the two pixels on the map is the same as the positional relationship between the corresponding two positions in the image 204.

In the present embodiment, the score map 201 indicates the likelihood that the detection target object is present at each of positions in the image. Each value in the score map 201 (each score) indicates a confidence that the object is present at the corresponding position in the image 204. Specifically, each value in the score map 201 has a value which increases as the likelihood that the object is present at the corresponding position increases. Here, when the value of the score map is greater than a predetermined threshold, an object can be determined to be present at the position in the image 204 corresponding to that value. Furthermore, the center of the object can be determined to be present at the position in the image 204 corresponding to a peak position in the score map (the position at which the score is the highest). For example, in the example in FIG. 2A, positions 201a and 201b having a score of 255 in the score map 201 can be determined to correspond to the center positions of objects. As mentioned earlier, a single position on the score map may be called a “pixel”. The score at a single position on the score map may also be called the “score of the corresponding pixel”.

Each value in the region width map 202 and the region height map 203 indicates an estimated value of a region width and a region height of the object when the object is present at the corresponding position in the image 204. Accordingly, the region width and the region height (W1, H1) of the object corresponding to the position 201a, and the region width and the region height (W2, H2) of the object corresponding to the position 201b, can be obtained from the region width map 202 and the region height map 203. The region (position and size) of the object (e.g., the head of a person) can be detected from the image 204 using the feature maps in this manner.

### Object Detection Processing

The configuration of an information processing apparatus that performs object detection processing according to one embodiment will be described next. FIG. 1B illustrates an example of the functional configuration of an information processing apparatus 120 that performs object detection processing. In one embodiment, the information processing apparatus 120 is the same apparatus as the information processing apparatus illustrated in FIG. 1A. In other words, the information processing apparatus 120 detects a region of an object by processing feature maps generated by the CNN processing unit 101. However, the information processing apparatus 120 may be an apparatus different from the information processing apparatus illustrated in FIG. 1A. The information processing apparatus 120 may process a feature map generated by an apparatus different from the information processing apparatus illustrated in FIG. 1A. As illustrated in FIG. 1B, the information processing apparatus 120 includes a peak detection unit 121, a list processing unit 122, and a region determination unit 123.

The peak detection unit 121 detects peak positions from a score map included in the feature maps. This processing makes it possible to exclude positions which do not correspond to the center position of the object from the subsequent processing. The peak detection unit 121 then generates a list indicating the detected peak positions (called a “peak list” hereinafter). The processing performed by the peak detection unit 121 will be described in detail later.

The list processing unit 122 processes the peak list generated by the peak detection unit 121. For example, the list processing unit 122 can rearrange the peak positions included in the peak list by score (e.g., in descending order). The list processing unit 122 can also exclude some peak positions from the peak list based on the scores indicated in the score map 201. For example, the list processing unit 122 can exclude peak positions having scores less than or equal to a threshold (i.e., object positions of low confidence) from the peak list. Such processing makes it possible to simplify subsequent processing, such as merger processing for detection results.

The region determination unit 123 determines the position and region of an object in the input image based on (i) the peak positions included in the peak list and (ii) the region width map and the region height map included in the feature maps. For example, the region determination unit 123 can determine a position in the input image corresponding to a peak position to be the center position of an object. The region determination unit 123 can obtain the width and height of an object region corresponding to the peak position by referring to the region width map and the region height map. The region determination unit 123 can then determine the position and region of the object in the input image based on (i) the peak position and (ii) the width and height of the object region corresponding to the peak position. At this time, the region determination unit 123 may determine the position and region of the object in the input image by performing scale conversion or linear correction on (i) the position on the peak map and (ii) the width and height of the object region indicated by the region width map and the region height map. For example, the region determination unit 123 can calculate (W1, H1) or (W2, H2) indicated in FIG. 2A. The region determination unit 123 can determine the peak position to be the position of an object in the input image in this manner.

The region determination unit 123 may also merge object detection results. For example, an object may appear large in the image, or the score threshold used in the peak detection may be low. In such a case, despite only one object being present, a plurality of positions in close proximity to each other may be obtained as a result of estimating the position of the object. In such a case, to narrow down the object detection results to a single object, the region determination unit 123 may combine a plurality of detection results (e.g., center positions) into a single result. A non-maximum suppression (NMS) technique can be used to combine the detection results, for example.

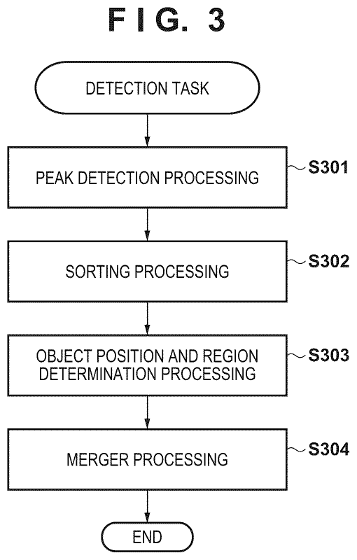

An object detection method according to one embodiment will be described next. FIG. 3 illustrates an example of a flowchart of an object detection task. According to this processing, an object and a region thereof are detected based on a feature map output from a final layer of the CNN processing unit 101.

In step S301, the peak detection unit 121 performs processing for detecting the peak position in the score map. As mentioned earlier, the peak detection unit 121 can generate a peak list indicating the detected peak positions. This processing makes it possible to accelerate the processing of steps S302 to S304. In other words, steps S302 to S304 (described later) can only process the peak positions included in the peak list. Step S301 will be described in greater detail later.

In step S302, the list processing unit 122 processes the peak list obtained in step S301, as mentioned earlier. In step S303, the region determination unit 123 determines the position of the object and the region thereof in the input image, for each of the peak positions in the peak list, as mentioned earlier. In step S304, the region determination unit 123 performs merger processing on the object detection results obtained in step S303, as mentioned earlier. The processing of steps S301 to S304 therefore makes it possible to detect an object from the input image.

### Peak Detection Processing

As described above, processing for detecting peak positions in the score map is performed in the object detection processing. This processing will be described in more detail hereinafter. Note that the peak position detection processing described hereinafter is not limited to the score map for object detection described above. Peak position detection processing such as that described hereinafter can be performed on any type of score map. The score map may be a two-dimensional map or a multidimensional map.

The configuration of an information processing apparatus that performs peak detection processing according to one embodiment will be described hereinafter. FIG. 1C illustrates an example of the functional configuration of an information processing apparatus 150 that performs peak detection processing. In one embodiment, the information processing apparatus 150 corresponds to the peak detection unit 121 illustrated in FIG. 1B. In one embodiment, the information processing apparatus 150 may be an apparatus different from the information processing apparatus illustrated in FIG. 1A. For example, the information processing apparatus 150 may process a score map generated by an apparatus different from the information processing apparatus illustrated in FIG. 1A. As illustrated in FIG. 1C, the information processing apparatus 150 includes a candidate extraction unit 151, a comparison unit 152, and a peak determination unit 153.

The candidate extraction unit 151 extracts peak position candidates. The processing performed by the comparison unit 152 and the peak determination unit 153 is performed for a position of interest (or a part thereof) (described later). The peak position candidates extracted by the candidate extraction unit 151 are used as positions of interest later. It can therefore be said that the candidate extraction unit 151 selects positions of interest.

In the present embodiment, the candidate extraction unit 151 selects a peak position candidate (i.e., a new position of interest) based on a relationship between (i) a score at the position of interest and (ii) a score at a first position within a region of a predetermined size around the position of interest. This position of interest is a peak position candidate previously extracted by the candidate extraction unit 151. It is therefore possible for the candidate extraction unit 151 to select a new position of interest in the vicinity of a position of interest.

The comparison unit 152 compares the score at the position of interest with a threshold. For example, the comparison unit 152 can determine whether the score indicated by the score map for the position of interest is less than a threshold h. The comparison unit 152 can perform such processing to determine whether to exclude the position of interest from the peak determination processing.

The peak determination unit 153 determines whether the position of interest indicates a peak position. This process may be called “peak determination processing” hereinafter. The peak determination unit 153 can determine whether the position of interest indicates a peak position according to determination criteria. This determination criteria are that the score at the position of interest satisfies a predetermined relationship with a score at each of positions in the region of the predetermined size around the position of interest. If the determination criteria are determined to be satisfied, the peak determination unit 153 can determine that the position of interest indicates a peak position. The peak determination unit 153 can determine the peak pixel indicating the peak position by comparing the score of a pixel of interest indicating the position of interest with the scores of neighboring pixels.

Here, the determination made by the peak determination unit 153 is skipped for positions not selected as positions of interest (peak position candidates). In other words, the peak determination unit 153 can determine that a position not selected by the candidate extraction unit 151 as a position of interest (a peak position candidate) does not indicate a peak position. This makes it possible to shorten the time required for the peak determination processing by reducing the number of positions of interest (peak position candidates) selected by the candidate extraction unit 151.

The peak determination unit 153 can also skip the determination for the position of interest in accordance with the determination made by the comparison unit 152. For example, the peak determination unit 153 can determine whether the peak determination processing for the position of interest indicates a peak position in response to the score at the position of interest being determined to be greater than or equal to the threshold h. On the other hand, the peak determination unit 153 can skip the determination as to whether the position of interest indicates a peak position in response to the score at the position of interest being determined to be less than the threshold h.

According to such a configuration, the peak detection is performed such that peak positions having low scores are not detected. In the present embodiment, the peak determination processing can also be skipped for positions having low scores. According to such a configuration, the processing time can be shortened as compared to a case where the peak determination unit 153 performs the peak determination processing for all positions in the score map. However, it is not necessary for the peak determination unit 153 to skip the determination for the position of interest in accordance with the determination made by the comparison unit 152. It is also not necessary for the information processing apparatus 150 to include the comparison unit 152.

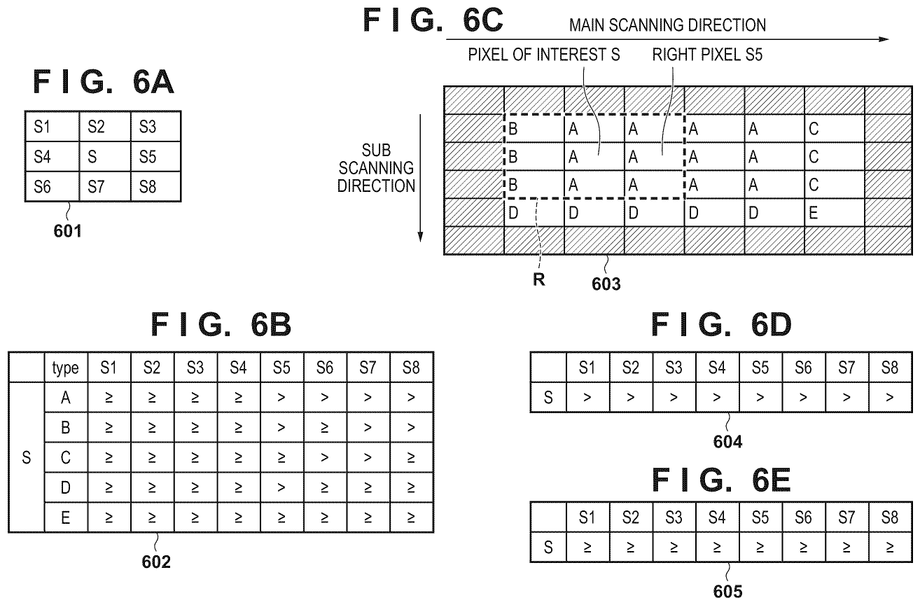

FIGS. 6A to 6E illustrate an example of a method for determining a peak pixel. The peak determination unit 153 can use a 3×3-pixel neighbor filter 601, illustrated in FIG. 6A, for the peak determination processing on the position of interest. In other words, the determination of the peak pixel can be made based on the relationship between the score of a pixel of interest S and the scores of neighbor pixels around the position of interest. In this example, the neighbor pixels of the pixel of interest S are pixels S1 to S8. FIG. 6B illustrates conditions 602 related to the relationship between the score of the pixel of interest S and the scores of the neighbor pixels S1 to S8, which is satisfied when the pixel of interest S indicates a peak position.

FIG. 6C illustrates a 6×8-pixel score map 603 subject to peak position detection processing. In FIG. 6C, a region R in the neighbor filter, corresponding to the pixel of interest S, is indicated by a dotted line rectangle. The conditions 602 differ depending on the pixel position of the pixel of interest on the score map 603. The letters A to E assigned to the pixels in FIG. 6C correspond to the “type” in FIG. 6B, and indicate the conditions used in the peak determination processing for the pixels having those letters. For example, the letter A is assigned to the pixel of interest S indicated in FIG. 6C. Accordingly, the conditions for “type=A”, indicated in FIG. 6B, are used in the peak determination processing for the pixel of interest S. In other words, the condition for determining that the pixel of interest S is a peak pixel is (the score of the pixel of interest≥the score of the neighbor pixels S1 to S4, respectively) and (the score of the pixel of interest S>the score of the neighbor pixels S5 to S8, respectively). Note that in this example, the pixels in the outer periphery of the score map 603 (the hatched parts; a dot pixel region) are excluded from the determination of the peak pixel.

Note that the determination conditions for the peak pixels are not particularly limited. However, using the conditions 602 illustrated in FIG. 6B makes it possible to extract one of a plurality of pixels as a peak pixel, even if a plurality of pixels having the same score are adjacent to each other. For example, it is conceivable to use conditions 604 illustrated in FIG. 6D. In the conditions 604, if the score of the pixel of interest S is greater than the score of each of the neighbor pixels S1 to S8 (>), the pixel of interest S is determined to be a peak pixel. However, using the conditions 602 makes it easy to detect the peak pixel when the scores of the pixels of interest and the neighbor pixels tend to be the same (for example, when a large face is detected). It is also conceivable to use conditions 605 illustrated in FIG. 6E. In the conditions 605, if the score of the pixel of interest S is greater than or equal to the score of each of the neighbor pixels S1 to S8 (≥), the pixel of interest S is determined to be a peak pixel. However, using the conditions 602 makes it easy to suppress the detection of a plurality of peak pixels representing the same object when the scores of the pixels of interest and the neighbor pixels tend to be the same (for example, when a large face is detected). Reducing the number of peak pixels detected makes it possible to increase the speed of processing in later stages.

When using the conditions 602, the conditions for “type=A” are used for the majority of pixels. However, even if the score of the pixel of interest is the same as the score of an adjacent pixel in the outer periphery of the score map 603, the conditions “type=B to E” are used for pixels in the vicinity of the outer periphery such that the pixel of interest is extracted as a peak pixel.

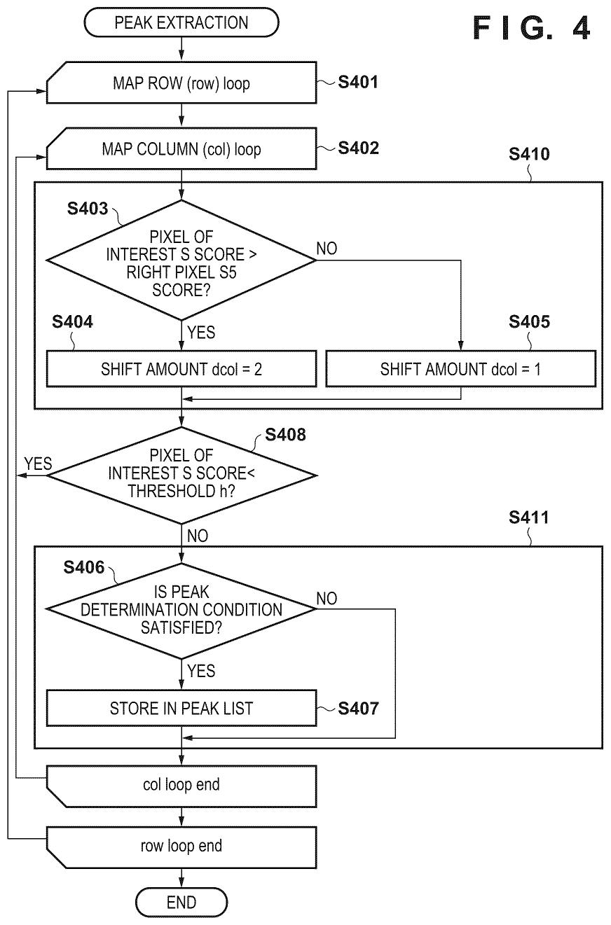

A peak position detection method according to one embodiment will be described in detail hereinafter with reference to the flowchart in FIG. 4. The processing of step S301 can be performed as follows, for example.

In step S401, the candidate extraction unit 151 sets a row in which the pixel of interest is to be selected. In the first instance of the processing of step S401, the candidate extraction unit 151 selects the first row of the score map as the row in which the pixel of interest is to be selected. In the second and subsequent instances of the processing of step S401, the candidate extraction unit 151 shifts the row in which the pixel of interest is to be selected in the sub scanning direction of the score map.

In step S402, the candidate extraction unit 151 sets a column in which the pixel of interest is to be selected. In the instance of step S402 immediately after the row in which the pixel of interest is to be selected is set in step S401, the candidate extraction unit 151 selects the first column of the score map as the column in which the pixel of interest is to be selected. In other cases, the candidate extraction unit 151 shifts the column in which the pixel of interest is to be selected in the main scanning direction of the score map. The shift amount at this time is indicated by a shift amount dcol (described later). In this manner, in steps S401 and S402, the row and column in which the pixel of interest is to be selected are set, and the pixel of interest is selected according to the row and column. The processing of steps S410, S408, and S411 is then performed on the selected pixel of interest.

In this manner, the candidate extraction unit 151 selects a plurality of positions of interest located along the main scanning direction of the score map. As will be described later, the candidate extraction unit 151 determines an interval (the shift amount dcol) between the position of interest and a new position of interest. The candidate extraction unit 151 then selects a new position of interest based on this interval (the shift amount dcol). As a result, the peak determination unit 153 determines whether each of the plurality of positions of interest located along the main scanning direction of the score map (at least some of the plurality of positions of interest selected by the candidate extraction unit 151) indicates a peak position.

However, if the pixel of interest according to the set row and column is a pixel not determined to be a peak pixel, such as a pixel in the outer periphery, the candidate extraction unit 151 can further shift the column in which the pixel of interest is to be selected in the main scanning direction of the score map. The shift amount dcol at this time may be set to 1. If in step S402 the column in which the pixel of interest is to be selected cannot be shifted in the main scanning direction of the score map (i.e., the final column was set), the loop of step S402 ends and the sequence returns to step S401. Even at this time, the candidate extraction unit 151 can set the shift amount dcol to 1.

Step S410 is pre-processing for step S411 (the peak determination processing; described later). In step S410, the candidate extraction unit 151 selects a peak position candidate (i.e., a new position of interest). Step S410 includes steps S403 to S405. In this processing, the shift amount dcol used to determine the pixel of interest in step S402 is set based on the result of comparing the score at the pixel of interest S with the score in the pixel S4 to the right thereof.

In step S403, the candidate extraction unit 151 compares the score at the position of interest with the score at a first position within a region of a predetermined size around the position of interest. The first position is located downstream from the position of interest in the main scanning direction of the score map, for example. In this example, the first position is a position adjacent to the position of interest. In other words, the candidate extraction unit 151 compares the score of the pixel of interest S with the score of the pixel S5 to the right thereof. However, the first position may be downstream from the position adjacent to the position of interest, as in a case where the processing for detecting the peak position and reduction processing are combined (described later).

In the present embodiment, the candidate extraction unit 151 determines whether the score at the position of interest is greater than the score at the first position. If the candidate extraction unit 151 determines that the score of the pixel of interest S>the score of the pixel S5, the sequence moves to step S404. However, if the candidate extraction unit 151 determines that the score of the pixel of interest S≤the score of the pixel S5, the sequence moves to step S405.

Step S404 is performed in response to the score at the position of interest being determined to be greater than the score at the first position. In step S404, the candidate extraction unit 151 sets the shift amount dcol to 2. In this case, in the instance of step S402 performed after steps S408 and S411, the column in which the pixel of interest is to be selected is shifted by two columns, and thus the pixel S5 is not selected as the pixel of interest. In other words, the pixel S5 is excluded from the peak determination processing in step S411. To rephrase, the candidate extraction unit 151 can select a second position (to the right of the pixel S5) that is different from the first position (the pixel S5) as a peak position candidate. The second position in this case is located downstream from the position of interest (the pixel of interest S) and the first position (the pixel S5) in the main scanning direction of the score map. In this example, the second position is a position adjacent to the first position. However, the second position may be downstream from the position adjacent to the first position, as in a case where a 5×5-pixel neighbor filter is used, and a case where the processing for detecting the peak position and reduction processing are combined (described later).

Step S405 is performed in response to the score at the position of interest being determined to be less than or equal to the score at the first position. In step S405, the candidate extraction unit 151 sets the shift amount dcol to 1. In this case, in the instance of step S402 performed after steps S408 and S411, the column in which the pixel of interest is to be selected is shifted by one column, and thus the pixel S5 is selected as the pixel of interest. In this manner, the candidate extraction unit 151 can select the first position (the pixel S5) as a new peak position candidate.

The setting of the shift amount dcol described above will be described in further detail. As mentioned earlier, the pixel of interest shifts in the main scanning direction. The score of a pixel of interest T being greater than the score of a pixel T+1 to the right thereof (i.e., the pixel S5) means that the score of the pixel T+1 is less than the score of a pixel T to the left thereof (i.e., the pixel S4). The pixel T+1 is therefore not determined to indicate a peak position according to the conditions 602. Accordingly, the peak determination processing for the pixel T+1 to the right of the pixel of interest can be skipped. In this manner, the shift amount dcol is set to 2 in order to skip the determination of the peak position for the pixel of interest to the right. On the other hand, if the score of the pixel of interest T is less than or equal to the score of the pixel T+1 to the right thereof (i.e., the pixel S5), it is possible that the pixel T+1 will be determined to indicate a peak position according to the conditions 602. The shift amount dcol is therefore set to 1 in order to avoid skipping the determination of the peak position for the pixel T+1 to the right of the pixel of interest.

The processing of steps S408 and S411 is then performed. In the present embodiment, the processing of steps S408 and S411 are performed for the position of interest. The new position of interest (peak position candidate) selected in step S410 is used in the next loop.

In step S408, the comparison unit 152 performs determination exclusion processing for determining whether to exclude the position of interest from the peak determination. The comparison unit 152 compares the score of the pixel of interest with the threshold h. If the comparison unit 152 determines that the score of the pixel of interest S<the threshold h, the sequence returns to step S402, and the next pixel of interest is selected. In other words, the processing of step S411 for the pixel of interest is not performed. Such a configuration suppresses the extraction of peak pixels having low scores.

In step S411, the peak determination unit 153 performs the peak determination processing on the position of interest. In this manner, the peak determination unit 153 extracts the peak position. Step S411 includes steps S406 and S407. In step S411, the peak determination unit 153 determines whether the pixel of interest indicates a peak position, as described above. For example, the peak determination unit 153 compares the score of the pixel of interest S with the scores at the neighbor pixels S1 to S8. If all the comparison results satisfy the conditions 602, the peak determination unit 153 determines that the pixel of interest is a peak pixel, and the sequence moves to step S407. If a comparison result that does not satisfy the conditions 602 is present, the pixel of interest is not determined to be a peak pixel, and the sequence returns to step S402.

In step S407, the peak determination unit 153 stores information on the pixel of interest determined to be a peak pixel in step S406 in the peak list. The information on the pixel of interest can include the score of the pixel of interest and position information of the pixel of interest on the score map, for example. The peak list can be implemented as an array in a memory.

The peak list can be generated through the processing described above. Based on the result of the determination by the peak determination unit 153 indicated in the peak list, the region determination unit 123 can estimate the position of the detection target object in the input image, as described above.

In the example illustrated in FIG. 4, the pre-processing step S410, the determination exclusion processing step S408, and the peak determination processing step S411 are performed in that order. In this manner, the determination exclusion processing step S408 can be performed before the peak determination processing step S411 in order to improve the processing speed. Additionally, to improve the processing speed, the pre-processing step S410 can be performed to determine whether to perform the peak determination processing on the pixel of interest (i.e., whether to extract the pixel as a peak position candidate) in the loop prior to the processing on the pixel of interest. As described above, it can be determined, in the pre-processing step S410, that the peak determination processing is to be skipped for the next pixel. It can also be determined, in the determination exclusion processing step S408, that the peak determination processing is to be skipped for the pixel of interest. In this manner, the peak determination processing step S411, which has a high processing load, can be skipped through the pre-processing step S410 and the determination exclusion processing step S408, which improves the processing speed.

According to this method, the processing speed can be improved as compared to a case where the peak determination processing is performed for all pixels. For example, the processing speed can be effectively improved when a small number of objects are detected from the input image and the majority of pixels are excluded from the peak determination processing through the determination exclusion processing step S408.

As described above, the peak determination unit 153 can determine that the position of interest indicates a peak position when the score at the position of interest and the score at each position in a region of a predetermined size around the position of interest satisfy a predetermined relationship. This predetermined relationship can include a relationship defined for each position within the region of the predetermined size. For example, the predetermined relationship can include a first relationship between (i) the score at the position of interest (e.g., the pixel of interest S) and (ii) the score at the first position (e.g., the pixel S5) within the region of the predetermined size. In the example in FIG. 6B, the first relationship (type=A) is that the score of the pixel of interest S>the score of the pixel S5.

The following method, for example, can be employed as a method by which the candidate extraction unit 151 selects a peak position candidate (i.e., a new position of interest). The candidate extraction unit 151 can select the first position as a peak position candidate in response to the score at the position of interest and the score at the first position being determined not to satisfy the first relationship in the peak determination processing for the position of interest. This corresponds to setting the shift amount dcol to 1 when the score of the pixel of interest S≤the score of the pixel S5, in the example in FIG. 4. The candidate extraction unit 151 can also select the first position as a peak position candidate in response to the score at the first position and the score at the position of interest being determined to satisfy a second relationship in the peak determination processing for the first position. Here, the predetermined relationship can include a second relationship between (i) the score at the position of interest (e.g., the pixel of interest S) and (ii) the score at the second position (e.g., the pixel S4) within the region of the predetermined size. In the example in FIG. 6B, the second relationship is that the score of the pixel of interest S≥the score of the pixel S4. According to the conditions 602 (type=A) indicated in FIG. 6B, the second relationship being satisfied in the peak determination processing for the first position is equivalent to the first relationship not being satisfied in the peak determination processing for the position of interest.

The candidate extraction unit 151 can also select the second position, which is different from the first position, as a peak position candidate in response to the score at the position of interest and the score at the first position being determined to satisfy the first relationship in the peak determination processing for the position of interest. This corresponds to setting the shift amount dcol to 2 when the score of the pixel of interest S>the score of the pixel S5, in the example in FIG. 4. The candidate extraction unit 151 can also select the second position as a peak position candidate in response to the score at the first position and the score at the position of interest being determined not to satisfy the second relationship in the peak determination processing for the first position. According to the conditions 602 (type=A) indicated in FIG. 6B, the second relationship not being satisfied in the peak determination processing for the first position is equivalent to the first relationship being satisfied in the peak determination processing for the position of interest.

In this manner, in the pre-processing step S410, the candidate extraction unit 151 selects a new position of interest so as to satisfy some of the determination criteria used in the peak determination processing. In other words, the candidate extraction unit 151 determines a portion of the conditions used by the peak determination unit 153 in the peak determination processing for the position of interest in advance for the peak position candidate (the new position of interest). Specifically, the candidate extraction unit 151 determines a portion of the conditions used in the peak determination processing for the pixels around the pixel of interest. The candidate extraction unit 151 then excludes, from the peak determination processing, positions that do not satisfy the portion of the conditions used in the peak determination processing. This configuration reduces the number of times the peak determination is performed.

As described above, the candidate extraction unit 151 can select the second position as a peak position candidate, without selecting the first position as a peak position candidate in response to the score at the position of interest being determined to be greater than the score at the first position. In one embodiment, the determination criteria used in the peak determination processing require at least that the score at a position of interest is greater than or equal to the score at each of positions in the region of the predetermined size around the position of interest. As described earlier, this predetermined relationship can include a relationship defined for each position within the region of the predetermined size. Here, the relationship defined for the specific position can require that the score at the position of interest be greater than the score at the specific position, or greater than or equal to the score at the specific position. For example, to satisfy the conditions 602, it is at least necessary for the score of the pixel of interest S to be greater than or equal to the scores of the other pixels (S1 to S8), regardless of the “type”. For this reason, if the score at the position of interest is greater than the score at the first position, the first position is not determined to indicate the peak position, regardless of the “type”. It is therefore not necessary for the candidate extraction unit 151 to select the first position as a peak position candidate.

In an example such as the conditions 602 described above, whether to select the first position as a peak position candidate can be determined by performing a peak determination for the position of interest (e.g., comparing the score of the pixel of interest S with the score of the pixel S5). In such a configuration, the candidate extraction unit 151 may select the peak position candidate (or determine the shift amount dcol) based on a result of comparing the scores by the peak determination unit 153. As another example, for the peak determination at the position of interest, the peak determination unit 153 may refer to a result of score comparison performed by the candidate extraction unit 151 to select a peak position candidate based on the score at the position of interest.

On the other hand, as illustrated in FIG. 4, the pre-processing step S410 for selecting a peak position candidate based on the score at the position of interest can be performed before the determination exclusion processing step S408 for the position of interest. The pre-processing step S410 can also be performed independent from the peak determination processing step S411 for the position of interest. The determination exclusion processing step S408 makes it possible to skip subsequent processing for the position of interest. On the other hand, by performing the pre-processing step S410 before the determination exclusion processing step S408, the peak position candidate selection (e.g., the determination of the shift amount dcol) in step S410 is performed even when the score at the position of interest is less than the threshold. This makes it possible to determine whether to skip the peak determination processing for the next pixel after the pixel of interest (e.g., the pixel to the right) even when the score at the position of interest is less than the threshold.

A peak detection method using a 3×3-pixel neighbor filter has been described thus far. However, a similar method can be used even when different a neighbor filter is used. The following will describe a case where a 5×5-pixel neighbor filter is used.

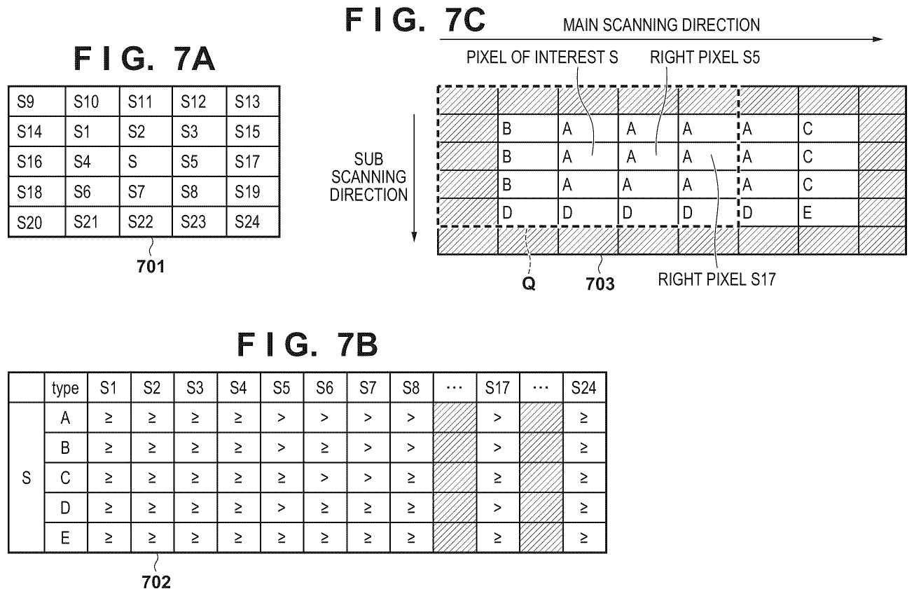

FIG. 7A illustrates a 5×5-pixel neighbor filter 701 that can be used by the peak determination unit 153. FIG. 7B illustrates conditions 702 related to the relationship between the score of the pixel of interest S and the scores of the neighbor pixels S1 to S24, which is satisfied when the pixel of interest S indicates a peak position. FIG. 7C illustrates a score map 703 subject to peak position detection processing. The score map 703 is the same as the score map 603 illustrated in FIG. 6C.

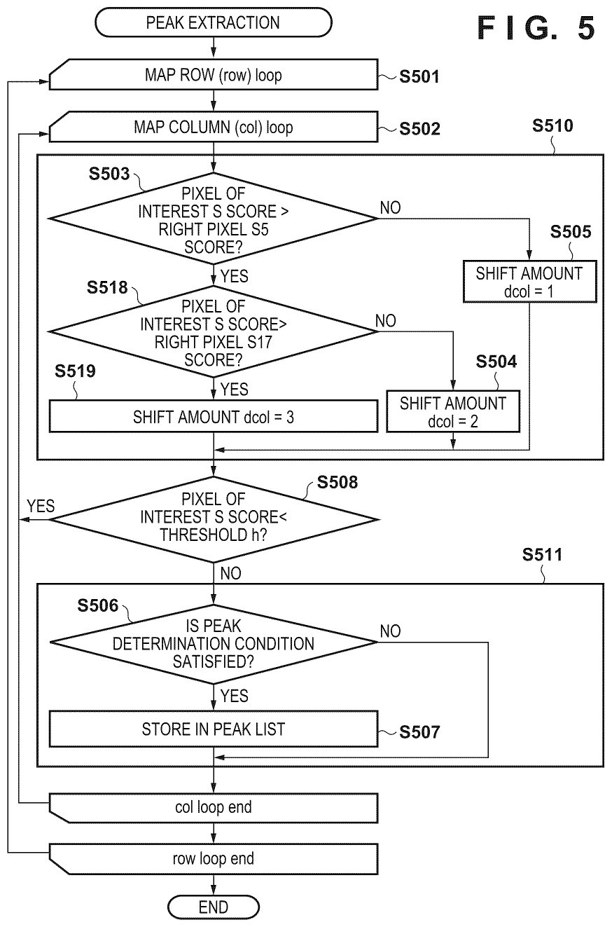

The peak detection processing using a 5×5-pixel neighbor filter can be performed as indicated by the flowchart illustrated in FIG. 5. The processing of step S301 can be performed as follows, for example.

Steps S501 and S502 are performed in the same manner as steps S401 and S402 illustrated in FIG. 4.

Step S510 is pre-processing for step S511 (the peak determination processing; described later). Step S510 includes steps S503 to S505, S518, and S519. In step S510, the shift amount dcol is set based on a result of comparing the score at the pixel of interest S with the scores in the consecutive pixels S5 and S17 to the right thereof.

Like step S403, in step S503, the candidate extraction unit 151 compares the score of the pixel of interest S with the score of the pixel S5 to the right thereof. If the candidate extraction unit 151 determines that the score of the pixel of interest S>the score of the pixel S5, the sequence moves to step S518. In step S518, the candidate extraction unit 151 sets the shift amount dcol to 1. However, if in step S503 the candidate extraction unit 151 determines that the score of the pixel of interest S≤the score of the pixel S5, the sequence moves to step S505.

In step S518, the candidate extraction unit 151 compares the score of the pixel of interest S with the score of the pixel S17 two pixels to the right of the pixel of interest S, through the same method as that used in step S403. If the candidate extraction unit 151 determines that the score of the pixel of interest S>the score of the pixel S17, the sequence moves to step S504. In step S504, the candidate extraction unit 151 sets the shift amount dcol to 2. However, if in step S518 the candidate extraction unit 151 determines that the score of the pixel of interest S≤the score of the pixel S17, the sequence moves to step S519. In step S519, the candidate extraction unit 151 sets the shift amount dcol to 3.

In this manner, the candidate extraction unit 151 compares the score at each of N consecutive positions following the position of interest with the score at the position of interest along the main scanning direction of the score map. The candidate extraction unit 151 can then set the shift amount dcol to N+1 in response to the score at the position of interest being determined to be greater than the score at each of the N consecutive positions.

The score of the pixel of interest T being greater than the score of a pixel T+2 two pixels to the right (i.e., the pixel S17) means that the score of the pixel T+2 is less than the score of the pixel T two pixels to the left (i.e., the pixel S16). The pixel T+2 is therefore not determined to indicate a peak position according to the conditions 702. Accordingly, the peak determination processing for the pixel T+2 to the right of the pixel of interest can be skipped. The determination in step S503 indicates that the pixel T+1 is not determined to indicate a peak position according to the conditions 702, and thus in step S519, the shift amount dcol can be set to 3.

Step S508 is performed in the same manner as step S408 illustrated in FIG. 4. Step S511 is also performed in the same manner as step S411 illustrated in FIG. 4, except that the neighbor filter 701 and the conditions 702 are used.

In this manner, using a larger neighbor filter makes it possible to increase the number of pixels for which the peak determination processing can be skipped (i.e., the shift amount dcol), which in turn makes it possible to detect the peak position even faster.

In the foregoing embodiment, whether to skip the peak determination processing for the pixel to the right is determined by comparing the score of the pixel of interest S with the score of the pixel to the right thereof (e.g., S5). However, when the main scanning direction is the vertical direction of the score map, whether to skip the peak determination processing for a pixel below can be determined by comparing the score of the pixel of interest with the score of the pixel below.

In the flowchart illustrated in FIG. 3, a processing step S302 is performed on the peak list in addition to the processing step S301 for detecting the peak position. However, sorting processing may be performed in step S407. In this case, the sorting processing in step S302 can be omitted.

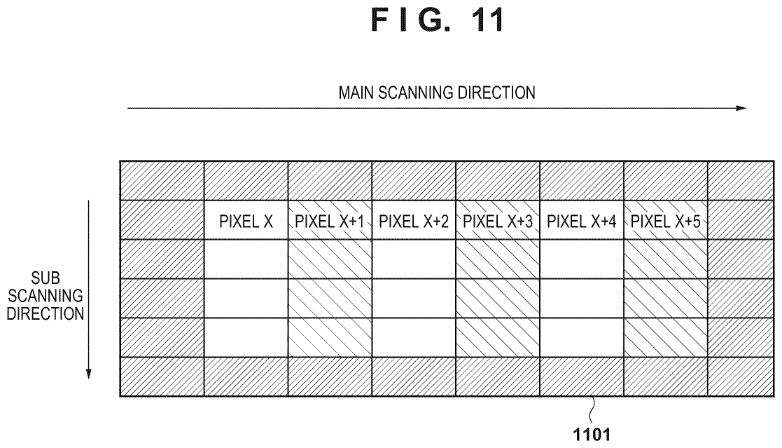

The processing for detecting the peak position and reduction processing can also be combined. For example, a peak position can be detected from among a plurality of positions selected to have an interval M from each other along the main scanning direction in the score map. A case where a ½ reduction is performed in the main scanning direction (M=2) will be described with reference to FIG. 11. FIG. 11 illustrates a score map 1101. The score map 1101 shows pixels in the outer periphery that are excluded from the determination of the peak pixel (the dense hatching), as well as pixels that are not referenced for the reduction processing (the sparse hatching). When the pixel of interest S is a pixel X, the pixel S5 to the right of the pixel of interest S is a pixel X+2, and the next pixel in the main scanning direction is a pixel X+4. Accordingly, in step S404, the shift amount dcol is set to 4. In step S405, the shift amount dcol is set to 2.

Generally, when reduction processing of 1/M is performed, the candidate extraction unit 151 can set the shift amount dcol to 2×M in response to the score at the position of interest being determined to be greater than the score at the position following the position of interest. Additionally, generally, when reduction processing of 1/M is performed, the candidate extraction unit 151 can set the shift amount dcol to M×(N+1) in response to the score at the position of interest being determined to be greater than the score at each of the N positions following the position of interest. Here, the position following the position of interest is included in a plurality of positions selected to have an interval M from each other along the main scanning direction in the score map. According to such an embodiment, the peak position can be detected more quickly, particularly from a score map in which many peak positions are present.

### Variation on Peak Detection Processing

In the foregoing embodiment, the pre-processing step S410 is performed in units of one pixel. Specifically, one new peak position candidate was selected in the vicinity of the position of interest by setting the shift amount in the main scanning direction. In the following example, the pre-processing is performed in units of 2×2 pixels. One peak pixel candidate is then selected from the 2×2 pixel block. In this case, the 2×2 pixel block to be processed is shifted by a fixed shift amount (i.e., in units of two pixels in the main scanning direction and two rows in the sub scanning direction).

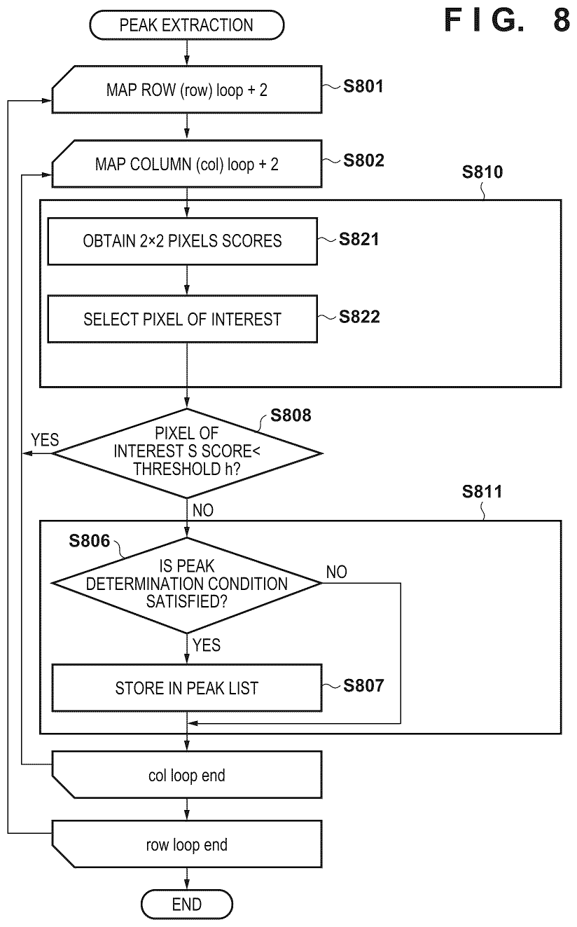

The peak detection processing in the present variation can be performed in accordance with the flowchart illustrated in FIG. 8. In steps S801 and S802, the candidate extraction unit 151 sets a 2×2 pixel block to be processed. The candidate extraction unit 151 can shift the pixel block while repeating the processing.

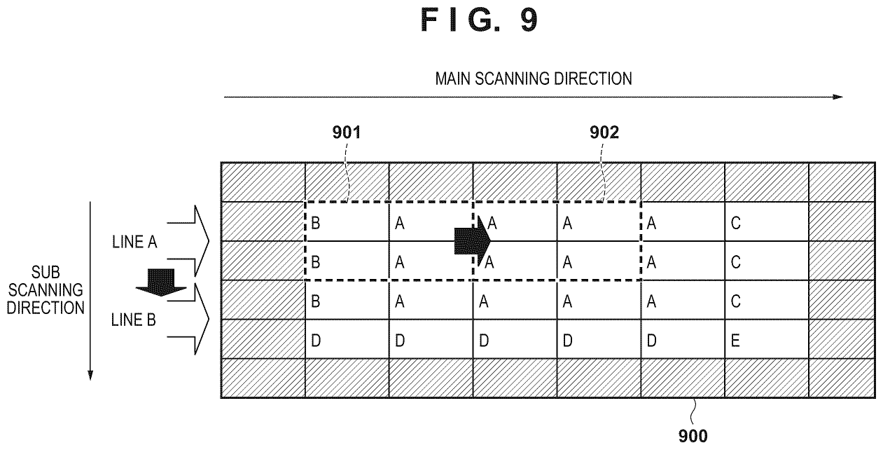

For example, in step S801, the candidate extraction unit 151 shifts the pixel block in the sub scanning direction. The candidate extraction unit 151 can shift the pixel block by two rows. As illustrated in FIG. 9, the candidate extraction unit 151 can shift the pixel block from line A to line B. Note that the score map 603 illustrated in FIG. 9 is the same as that illustrated in FIG. 6C. In step S802, the candidate extraction unit 151 shifts the pixel block in the main scanning direction. The candidate extraction unit 151 can shift the pixel block by two pixels. As illustrated in FIG. 9, the candidate extraction unit 151 can shift the pixel block from a position 901 to a position 902.

A pre-processing step S810 includes steps S821 and S822. In step S810, the candidate extraction unit 151 can select one or more peak position candidates (i.e., positions of interest) from a region of a fixed size set in steps S801 and S802. In the following example, the candidate extraction unit 151 selects a peak position candidate from the 2×2 pixel block. Even in the present variation, the candidate extraction unit 151 can select a peak position candidate using the conditions 602 illustrated in FIG. 6B, which are used in the peak determination processing. The neighbor filter used in this example is the neighbor filter 601 illustrated in FIG. 6A.

In step S821, the candidate extraction unit 151 obtains a score for each pixel in the 2×2 pixel block.

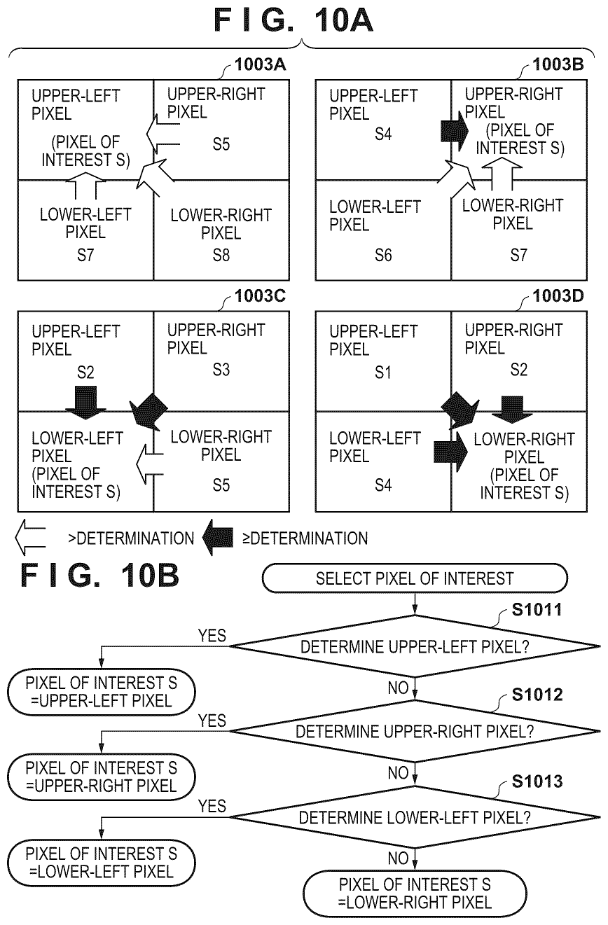

In step S822, the candidate extraction unit 151 extracts a peak position candidate from the 2×2 pixel block based on the scores obtained in step S821. The candidate extraction unit 151 can determine the peak position candidate in accordance with the flowchart illustrated in FIG. 10B.

In step S1011, the candidate extraction unit 151 determines whether to select the pixel in the upper-left corner of the 2×2 pixel block as the peak position candidate. Here, the candidate extraction unit 151 can select the peak position candidate (i.e., the position of interest) so as to satisfy some of the determination criteria used in the peak determination processing. For example, the candidate extraction unit 151 can make this determination by comparing the score of the pixel in the upper-left corner of the 2×2 pixel block with the score of each of the other pixels in the 2×2 pixel block. The candidate extraction unit 151 can make this determination in accordance with conditions 602.

The processing in step S1011 will be described with reference to a condition 1003A indicated in FIG. 10A. Conditions 1003A to 1003D indicate the conditions for the case where the “type” is A. The condition 1003A indicates the pixel positions of the other pixels when the neighbor filter 601 is applied to the upper-left pixel. In other words, if the upper-left pixel is the pixel of interest S, the upper-right pixel, the lower-left pixel, and the lower-right pixel are pixels S5, S7, and S8, respectively.

The condition 1003A also indicates a condition for the relationship between the score of the upper-left pixel and the score of each of the other pixels, for determining that the upper-left pixel is a peak position candidate. According to the condition 1003A, the condition for determining that the upper-left pixel is a peak position candidate is that the score of the upper-left pixel>the scores of the upper-right pixel, the lower-left pixel, and the lower-right pixel, respectively. This condition 1003A is part of the conditions 602 used in the peak determination processing. For example, according to the conditions 602, the condition for determining that the pixel of interest S is a peak position candidate is that the score of the upper-left pixel (the pixel of interest S)>the scores of the upper-right pixel (the pixel S5), the lower-left pixel (the pixel S7), and the lower-right pixel (the pixel S8), respectively. When this condition is satisfied, the scores of the upper-right pixel (the pixel S5), the lower-left pixel (the pixel S7), and the lower-right pixel (the pixel S8) are smaller than the score of the upper-left pixel (the pixel of interest S). The upper-right pixel, the lower-left pixel, and the lower-right pixel are therefore not determined to be peak pixels. As such, the upper-right pixel, the lower-left pixel, and the lower-right pixel can be excluded from the peak position candidates. The candidate extraction unit 151 can therefore select the upper-left pixel as a peak position candidate. Conversely, if the condition 1003A is not satisfied, the upper-left pixel is not determined to be a peak pixel. The candidate extraction unit 151 can therefore exclude the upper-left pixel from the peak position candidates.

If the condition 1003A is not satisfied, the sequence moves to step S1012. In step S1012, the candidate extraction unit 151 determines whether to select the pixel in the upper-right corner of the 2×2 pixel block as the peak position candidate. When the condition 1003B is satisfied, the candidate extraction unit 151 can select the upper-right pixel as a peak position candidate. This condition 1003B, too, is part of the conditions 602 used in the peak determination processing. The condition 1003B is satisfied when the score of the upper-right pixel>the score of the lower-left pixel, the score of the upper-right pixel>the score of the lower-right pixel, and the score of the upper-right pixel≥the score of the upper-left pixel. In this case, the scores of the lower-left pixel and the lower-right pixel are smaller than the score of the upper-right pixel, and those pixels are therefore not determined to be peak pixels. In step S1011, the upper-left pixel has already been excluded from the peak pixel candidates. As such, of the pixels in the 2×2 pixel block, only the upper-right pixel can be determined to be a peak pixel. The candidate extraction unit 151 can therefore select the upper-right pixel as a peak position candidate. Conversely, if the condition 1003B is not satisfied, the upper-right pixel is not determined to be a peak pixel. The candidate extraction unit 151 can therefore exclude the upper-right pixel from the peak position candidates.

Furthermore, if the condition 1003B is not satisfied, the sequence moves to step S1013. In step S1012, the candidate extraction unit 151 determines whether to select the pixel in the lower-left corner of the 2×2 pixel block as the peak position candidate. When the condition 1003C is satisfied, the candidate extraction unit 151 can select the upper-right pixel as a peak position candidate. This condition 1003C, too, is part of the conditions 602 used in the peak determination processing. The condition 1003C is satisfied when the score of the lower-left pixel>the score of the lower-right pixel, the score of the lower-left pixel≥the score of the upper-left pixel, and the score of the lower-left pixel≥the score of the upper-right pixel. In this case, the score of the lower-right pixel is smaller than the score of the lower-left pixel, and that pixel is therefore not determined to be a peak pixel. In steps S1011 and S1012, the upper-left pixel and the upper-right pixel have already been excluded from the peak pixel candidates. As such, of the pixels in the 2×2 pixel block, only the lower-left pixel can be determined to be a peak pixel. The candidate extraction unit 151 can therefore select the lower-left pixel as a peak position candidate. Conversely, if the condition 1003C is not satisfied, the lower-left pixel is not determined to be a peak pixel. The candidate extraction unit 151 can therefore exclude the lower-left pixel from the peak position candidates.

Furthermore, if the condition 1003C is not satisfied, the sequence moves to step S1014. In step S1012, the candidate extraction unit 151 selects the pixel in the lower-right corner of the 2×2 pixel block as the peak position candidate. The upper-left pixel, the upper-right pixel, and the lower-left pixel have already been excluded from the peak pixel candidates, and thus the candidate extraction unit 151 can select the lower-right pixel as the peak position candidate. In this case, it is not necessary to determine whether the condition 1003D is satisfied. Note that the condition 1003D is part of the conditions 602 used in the peak determination processing, and is a necessary condition for determining that the lower-right pixel is a peak pixel. On the other hand, if the conditions 1003A to C are not satisfied, the condition 1003D is satisfied.

In this manner, when using the conditions 602, the candidate extraction unit 151 can select one pixel, in the 2×2 pixel block, that can be determined to be a peak pixel, as a peak position candidate. Furthermore, in this case, the three pixels not selected as peak position candidates will not be determined to be peak pixels. In other words, the peak extraction for the 2×2 pixel block will be completed by the peak determination processing being performed for the peak position candidates. It is therefore not necessary to change the shift amount in steps S801 and S802. In other words, a fixed shift amount dcol of 2 can be used. As described above, the candidate extraction unit 151 can select a peak position candidate (i.e., a position of interest) in accordance with the conditions 1003A to 1003D, which correspond to respective positions in a region of a fixed size and which define some of the conditions 602 used for peak determination.

The processing of steps S808 and S811 is performed in the same manner as steps S408 and S411 illustrated in FIG. 4. However, the processing of steps S808 and S811 is performed on the peak position candidate (pixel of interest) selected in step S810. Note that the order of steps S810 and S808 may be reversed. In this case, in step S808, the comparison unit 152 may compare the maximum value of the scores among the 2×2 pixels with the threshold h. If the maximum value of the scores among the 2×2 pixels is less than the threshold h, the processing of S810 and S811 for the 2×2 pixel block can be skipped. According to this configuration, the peak determination processing several pixels in each of 2×2 pixel blocks can be skipped.

According to the present variation, the number of instances of peak determination processing can be reduced by selecting the peak position candidates in units of 2×2 pixels. This makes it possible to accelerate the peak position detection.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-095782, which was filed on Jun. 9, 2023 and which is hereby incorporated by reference herein in its entirety.

What is claimed is:

1. An information processing apparatus comprising:
one or more memories storing instructions;
and one or more processors that execute the instructions to:
determine, in order to detect a peak position in a score map, whether a position of interest in the score map indicates the peak position; and
select a new position of interest based on a relationship between (i) a score at the position of interest and (ii) a score at a first position within a region of a predetermined size around the position of interest.

2. The information processing apparatus according to claim 1,
wherein the first position is located downstream from the position of interest in a main scanning direction of the score map.

3. The information processing apparatus according to claim 1,
wherein the one or more processors execute the instructions to select the first position as the new position of interest when the score at the position of interest is determined to be less than or equal to the score at the first position.

4. The information processing apparatus according to claim 3,
wherein the one or more processors execute the instructions to select a second position, different from the first position, as the new position of interest when the score at the position of interest is determined to be greater than the score at the first position.

5. The information processing apparatus according to claim 4,
wherein the first position is located downstream from the position of interest in a main scanning direction of the score map, and the second position is located downstream from the first position in the main scanning direction of the score map.

6. The information processing apparatus according to claim 1,
wherein the one or more processors execute the instructions to determine that a position not selected as the position of interest does not indicate the peak position.

7. The information processing apparatus according to claim 1,
wherein the one or more processors execute the instructions to determine whether the position of interest is the peak position according to a determination criterion, and
the determination criterion is that the score at the position of interest and a score at each of positions in the region of the predetermined size around the position of interest satisfy a predetermined relationship.

8. The information processing apparatus according to claim 7,
wherein the predetermined relationship includes a first relationship between the score at the position of interest and the score at the first position in the region of the predetermined size, and
the one or more processors execute the instructions to select the first position as the new position of interest when the score at the position of interest and the score at the first position are determined not to satisfy the first relationship.

9. The information processing apparatus according to claim 8,
wherein the one or more processors execute the instructions to select a second position, different from the first position, as the new position of interest when the score at the position of interest and the score at the first position are determined to satisfy the first relationship.

10. The information processing apparatus according to claim 8,
wherein the first relationship is that the score at the position of interest is greater than the score at the first position.

11. The information processing apparatus according to claim 9,
wherein the first position is located downstream from the position of interest in a main scanning direction of the score map, and the second position is located downstream from the first position in the main scanning direction of the score map.

12. The information processing apparatus according to claim 1,
wherein the one or more processors execute the instructions to:
determine whether each of a plurality of positions of interest located along a main scanning direction of the score map indicates a peak position, the plurality of positions of interest each being the position of interest; and
set an interval between (i) each of the plurality of positions of interest and (ii) the new position of interest, and select the new position of interest based on the interval.

13. The information processing apparatus according to claim 12,
wherein the one or more processors execute the instructions to set the interval to N+1 when the score at the position of interest is determined to be greater than a score at N consecutive positions following the position of interest along the main scanning direction of the score map.

14. The information processing apparatus according to claim 12,
wherein the information processing apparatus detects a peak position from among a plurality of positions selected to have an interval M from each other along the main scanning direction in the score map, and
the one or more processors execute the instructions to set the interval to M×(N+1) when the score at the position of interest is determined to be greater than the score at each of N consecutive positions, among the plurality of positions, that follow the position of interest.

15. The information processing apparatus according to claim 1,
wherein the one or more processors execute the instructions to:
compare the score at the position of interest with a threshold; and
determine whether the position of interest indicates a peak position when the score at the position of interest is determined to be greater than or equal to the threshold.

16. The information processing apparatus according to claim 1,
wherein the score map indicates a likelihood that a detection target object is present at each of positions in an image, and
the one or more processors execute the instructions to estimate a position of the detection target object in the image based on a result of the determining.

17. The information processing apparatus according to claim 1, wherein the one or more processors execute the instructions to:
generate the score map based on a likelihood that an object is present at each of positions in an input image; and
determine a position of the object in the input image for the peak position.

18. An information processing apparatus comprising:
one or more memories storing instructions; and
one or more processors that execute the instructions to:
select a position of interest in a score map;
compare the score at the position of interest with a threshold; and
determine whether the position of interest indicates a peak position according to a determination criterion in order to detect a peak position in the score map, in response to the score at the position of interest being determined to be greater than or equal to a threshold,
wherein the determination criterion includes the score at the position of interest and a score at each of positions in a region of a predetermined size around the position of interest satisfying a relationship defined for each of the positions, and
the one or more processors execute the instructions to select the position of interest to satisfy a part of the determination criterion.

19. The information processing apparatus according to claim 18,
wherein the one or more processors execute the instructions to select one position of interest from a region of a fixed size.

20. An information processing method comprising:
determining, in order to detect a peak position in a score map, whether a position of interest in the score map indicates the peak position; and
selecting a new position of interest based on a relationship between (i) a score at the position of interest and (ii) a score at a first position within a region of a predetermined size around the position of interest.

21. An information processing method comprising:
selecting a position of interest in a score map;
comparing the score at the position of interest with a threshold; and
determining whether the position of interest indicates a peak position according to a determination criterion in order to detect a peak position in the score map, in response to the score at the position of interest being determined to be greater than or equal to a threshold,
wherein the determination criterion includes the score at the position of interest and a score at each of positions in a region of a predetermined size around the position of interest satisfying a relationship defined for each of the positions, and
wherein the selecting includes selecting the position of interest to satisfy a part of the determination criterion.

22. A non-transitory computer-readable medium storing computer-executable instructions executable by a computer to perform a method comprising:
determining, in order to detect a peak position in a score map, whether a position of interest in the score map indicates the peak position; and
selecting a new position of interest based on a relationship between (i) a score at the position of interest and (ii) a score at a first position within a region of a predetermined size around the position of interest.

23. A non-transitory computer-readable medium storing computer-executable instructions executable by a computer to perform a method comprising:
selecting a position of interest in a score map;
comparing the score at the position of interest with a threshold; and
determining whether the position of interest indicates a peak position according to a determination criterion in order to detect a peak position in the score map, in response to the score at the position of interest being determined to be greater than or equal to a threshold,
wherein the determination criterion includes the score at the position of interest and a score at each of positions in a region of a predetermined size around the position of interest satisfying a relationship defined for each of the positions, and
wherein the selecting includes selecting the position of interest to satisfy a part of the determination criterion.
